(19) United States
(12) Patent Application Publication
(10) Pub. No.: US 2024/0342872 A1
(43) Pub. Date: Oct. 17, 2024

(54) Impact or Impulse Wrench and Method for Screwing in a Screw

(71) Applicant: Würth International AG, Chur (CH)

(72) Inventors: Andreas Wunderlich, Kupferzell (DE); Svent Matthiesen, Karlsruhe (DE); Patric Grauberger, Karlsruhe (DE); Andreas Wettstein, Feldkirch (AT)

(21) Appl. No.: 18/292,462

(22) PCT Filed: Aug. 1, 2022
(86) PCT No.: PCT/EP2022/071580

§ 371 Date: Jan. 26, 2024

(30) Foreign Application Priority Data
Aug. 2, 2021 (DE) 10 2021 208 359.5

(51) Int. Cl. B25B 21/02; B25B 23/145; B25B 23/147

(52) U.S. Cl. CPC B25B 21/02; B25B 23/1453; B25B 23/1475

(57) ABSTRACT

The invention relates to an impact or impulse wrench having a drive motor and an output shaft, an impact or impulse unit being located between the drive motor and the output shaft, and the wrench having a back stop mechanism that cooperates with the output shaft in order to prevent, at least to some extent, reverse rotation of the output shaft.

### FIELD OF THE INVENTION

The invention relates to a drive or impact wrench having a drive motor and an output shaft and a drive or impact unit for accelerating the output shaft at short time intervals. The invention also relates to a return stop for use with a drive or impact wrench. The invention also relates to a method for screwing in a screw with a drive or impact wrench having a drive motor, an output shaft and a drive or impact unit for accelerating the output shaft at short time intervals, wherein a plurality of sequential rotary impacts are applied to the screw by means of the output shaft of the drive or impact wrench.

### BACKGROUND

With a drive or impact wrench an output shaft and a screw which is connected to the output shaft and which is intended to be screwed into a workpiece are accelerated at short time intervals, which is also referred to as sequential rotary impacts. If a screw is screwed in with a drive or impact wrench, wherein such drive or impact wrenches are also referred to as rotary impact wrenches, the screw shaft is turned or twisted or distorted with each rotary impact as a result of the energy which is introduced by means of the drive construction in the screw head relative to the thread until the torsion torque of the shaft is higher than the screwing-in torque of the thread. If a wood screw is screwed into wood with a rotary impact wrench, the screw is initially turned or twisted until the torsion torque of the shaft is higher than the screwing-in torque of the thread in the wood and only then is the screw slightly screwed into the wood. At the end of the rotary impact, the resilient torsion which has been introduced into the shaft decreases completely. With each of the next rotary impacts, therefore, the rotary impact wrench must first turn or twist the shaft again until the torsion torque of the shaft is higher than the screwing-in torque of the thread in the wood before the screw continues to be screwed in. When a screw is screwed into wood, the screwing-in torque increases as the screwing-in depth increases. If the rotary impact energy which is applied by the rotary impact wrench and which twists the screw head relative to the thread of the screw which is intended to be screwed in is less than the energy which is required to twist or distort the screw until the thread continues to be turned in the wood, the entire rotary impact energy is introduced into the shaft which rotates and which acts as a torsion bar without the thread being screwed further into the wood. This energy which turns, twists or distorts the shaft with each rotary impact is in the shaft of the screw at least partially converted into thermal energy.

If a rotary impact wrench with a higher rotary impact energy is used, with each rotary impact the screw shaft is turned, twisted or distorted until the torsion torque of the shaft is higher than the screwing-in torque of the thread in the wood and only then is a proportion of the rotary impact energy which has been introduced transferred into screwing in the screw. For this reason, screws with a long shaft can be screwed only slowly or not at all with a rotary impact wrench in comparison with screws with a short shaft. For this reason, in the case of long wood screws, predrilling may be required in order to prevent the shaft from tearing off.

### SUMMARY

With the invention, a drive or impact wrench and a method for screwing in a screw with a drive or impact wrench is intended to be improved.

According to the invention, to this end, a drive or impact wrench having the features of claim 1 and a method having the features of claim 10 is provided. Advantageous further developments of the invention are set out in the dependent claims.

With a drive or impact wrench having a drive motor, an output shaft and a drive or impact unit for accelerating the output shaft at short time intervals, in other words for producing rotary impacts, a return stop which cooperates with the output shaft is provided in order to at least partially prevent a backward rotation of the output shaft.

By preventing the backward rotation of the output shaft, a spring back of the shaft, that is to say, a backward rotation of the screw shaft after a rotary impact, is no longer completely possible. The energy of the next rotary impact then no longer has to completely, turn, twist or distort the screw shaft. A greater portion of the rotary impact energy can thereby be used for the screwing-in action than with conventional drive or impact wrenches. In contrast to conventional drive or impact wrenches, the operator of the drive or impact wrench thereby has to apply or resist a reverse torque. This can of course also be carried out using an apparatus. However, the advantage of the more rapid screwing-in far outweighs these disadvantages. The advantage of the invention thus involves the shaft of the screw not having to be turned, twisted or distorted from the start point with each rotary impact of the drive or impact wrench until the screw continues to be screwed in. A screw can thereby be screwed in more quickly. The torque or reverse torque which the operator has to resist is determined by the angle about which the shaft of the screw is twisted about itself and the mechanical properties of the shaft of the screw. The prevention of the reverse torque of the output shaft by means of the return stop can be carried out in different manners. For example, the return stop can be produced by means of an appropriate control of the drive motor of the drive or impact wrench. As soon as the output shaft begins to rotate backward, the drive motor of the drive or impact wrench can be supplied with electrical power and consequently brought into operation in order to at least partially prevent a backward rotation of the output shaft, for example, in order to brake with a predefined braking torque. The return stop may further also be in the form of a separate electric motor, a brake, a hydraulic motor or also a mechanical return stop.

The impact of the impact wrench is transferred from the head of the impact wrench to the head of the screw by means of the bit (output) to the drive recess in the screw head. The impact wrench can transfer to the screw head during the impact a maximum torque Mmax which is dependent on the construction of the impact wrench, the dimensions of the screw which is intended to be screwed in, the strength of the wood and the plug connection of the bit of the impact wrench in the head of the screw. This maximum torque which results from the impact under virtually static consideration cannot be greater than the screwing-in torque of the screw into the wood. After the impact of the impact wrench, the torsion/twisting which is generated between the screw head and screw tip during screwing in decreases. This backward rotation is intended to be absorbed by a return stop. However, it may be the case that, with large screws and rapid absorption of the backward rotation, the torque which is transferred to the user by the torsion via the return stop becomes too great. This reverse torque which brings about a restoring force on the impact wrench is with small screw diameters very small (Ø5 approximately 8 Nm) and with large screw diameters very large (Ø12 approximately 50 Nm).

In one variant, only one return stop which in the event of a backward rotation of the screw head engages at a specific angle is provided, wherein this angle can preferably be adjusted by a user.

In a second variant, both a slip clutch and a return stop are provided, wherein both are arranged between the output of the impact wrench and the housing of the impact wrench. In this variant, the torque of the slip clutch can be adjusted, preferably by the user.

In a third variant, both the return stop and the slip clutch are provided, wherein both can preferably be adjusted by the user.

The impact wrench applies to the screw head, during the time in which energy is generated in the impact wrench for the next impact, a minimal torque Mmin which corresponds to the torsion torque of the screw in the incomplete return thereof. This minimal torque is the torque which the user has to maintain during the screwing-in operation of the screw into the wood. During the screwing-in operation, the torque consequently changes between the values Mmin and Mmax. For optimum screwing in, the ratio of Mmax to Mmin is from 1.0 to 10 (100 Nm to 10 Nm or 10+Nm to 10 Nm). In another advantageous embodiment, this ratio is a maximum of approximately 1:50.

In another embodiment, provision is made for the resilient pretensioning force to be increased. The net restoring torque which the operator of the impact wrench has to support can thereby be increased to at least 8% of the maximum torque Mmax. The torque Mmin is thus 8% of Mmax. The resilient pretensioning force is in particular a force by means of which a slip coating of the slip clutch is pressed against a friction face.

In a further development of the invention, the return stop has means in order to limit a reverse torque, which acts on the return stop, of the output shaft to a predefined maximum value.

In this manner, it may be possible for the reverse torque which has to be applied by an operator or a suitable apparatus to remain within predefined limits which can be readily applied or maintained, for example, by an operator. The means may, for example, be in the form of a slip clutch or the like. The level of the maximum value of the reverse torque may have different values, for example, also depending on whether the drive or impact wrench is used for overhead work on a ladder or in another manner. The significant aspect is that the backward rotation of the screws when screwing in is not completely prevented and the backward rotation is also not abruptly stopped, but instead in such a manner that a maximum reverse torque occurs and acts on a handle of the drive or impact wrench, wherein this maximum reverse torque can be counteracted by an operator or an apparatus without safety risks.

In a further development of the invention, the means are constructed to limit the reverse torque to a value between 5 Nm and 30 Nm, in particular of 20 Nm.

In a further development of the invention, the return stop is in the form of a mechanical return stop, in particular a freewheel or a ratchet having locking detents, a rolling freewheel, a freewheel having several clamping members or a spring winding freewheel. The return stop may also have locking members or clamping members which run on curved paths until a locking action occurs. The reverse torque can consequently bring about the locking itself.

In a further development of the invention, the return stop has a ratchet with locking detents and a gear ring, wherein the locking detents of the ratchet in the event of a backward rotation of the drive shaft are inserted by mechanical actuation means into the gear ring of the return stop in a forcibly controlled manner.

By means of a forced control of the locking detents, wherein the backward rotation of the output shaft can be used for this, it is possible to produce the return stop in a highly dynamic manner. Conventional freewheels and tool ratchets are generally not capable of stopping a backward rotation so rapidly, as required when at least partially preventing the backward rotation of the output shaft of a drive or impact wrench when wood screws are screwed in. The invention proposes to this end a highly dynamic return stop and specifically a highly dynamic ratchet. For example, the locking detents may also be made from highly resistant but light material and it is, for example, also possible not to rotate the locking detents themselves with the output shaft, but instead also to rotate the gear ring. An improvement of the dynamic or the engagement time of the locking detent can thereby also be achieved.

In a further development of the invention, the return stop is in the form of a brake, in particular a hydraulically actuated or mechanically actuated brake.

For example, a disk brake, drum brake or band brake can be used.

In a further development of the invention, the return stop is constructed in a hydraulic manner, in particular in the form of a hydraulic motor.

In a further development of the invention, the return stop is constructed in an electrical manner, in particular in the form of an electric motor or an electric control unit which cooperates with the drive motor of the drive or impact wrench.

For example, a magnetic brake can be used, where applicable in combination with a mechanical brake or with locking detents. The return stop may, for example, be constructed electrically in that, in addition to the drive motor of the drive or impact wrench, a separate electric motor is used. This electric motor, as soon as the backward rotation of the output shaft begins, can then be supplied with electrical power in order to limit the backward rotation and in particular in order to limit the reverse torque of the output shaft to a predefined maximum value. In the context of the invention, however, with an electric construction of the return stop, it is also possible by means of the drive motor of the drive or impact wrench and a suitable electronic control unit to at least partially prevent the backward rotation of the output shaft. The backward rotation of the output shaft is, for example, detected by an appropriate sensor. In response to the beginning of the backward rotation, the drive motor of the drive or impact wrench is supplied with electrical power and the backward rotation of the output shaft can thereby be at least partially prevented and in particular the reverse torque can be limited to a predefined maximum value.

As a result of the invention, a return stop for use with a drive or impact wrench is also proposed, wherein the return stop cooperates with an output shaft of the drive or impact wrench and wherein the return stop is constructed to at least partially prevent a backward rotation of the output shaft.

The return stop may be in the form of a separate component which can in particular be retrofitted to a drive or impact wrench. The return stop according to the invention can then be further developed in the same manner as a return stop which is connected to the drive or impact wrench or which is integrated in the drive or impact wrench. A return stop in the form of a separate component, for example, for placing on an output shaft of a drive or impact wrench, has significant advantages in that, when screwing in long wood screws, the return stop can be connected to the drive or impact wrench, but if, for example, short wood screws or wheel screws of a motor vehicle are screwed in, the return stop can be omitted.

A method for screwing in a screw with a drive or impact wrench having a drive motor, an output shaft and a drive or impact unit for accelerating the output shaft at short time intervals, in other words to produce rotary impacts, is also provided, wherein the steps of applying out a plurality of sequential rotary impacts to the screw by means of the output shaft of the drive or impact wrench and at least partially preventing any backward rotation of the output shaft between two rotary impacts are provided.

In a further development of the invention, there is a limiting of the reverse torque of the output shaft to a predefined limit value between 5 Nm and 30 Nm, in particular of 20 Nm.

Other features and advantages of the invention will be appreciated from the claims and the following description of preferred embodiments of the invention in conjunction with the drawings. Individual features of the different embodiments illustrated in the drawings and described in the description can be combined with each other in any manner without exceeding the scope of the invention. This also applies to the combination of individual features of different embodiments without additional individual features with which they are illustrated or described in context.

### BRIEF DESCRIPTION OF THE DRAWINGS

In the drawings:

FIG. 1 shows a schematic illustration of a drive or impact wrench according to the invention, a screw and a workpiece, into which the screw is screwed,

FIG. 2 shows a graph relating to a progression of the torque on the head of a screw over the torsion angle on the head of the screw when screwing in with a conventional drive or impact wrench,

FIG. 3 shows the torque progression on the head of a screw over the torsion angle on the head of the screw when screwing in with a drive or impact wrench according to a first embodiment of the invention,

FIG. 4 shows a graph of the torque on the head of a screw over the torsion angle on the head of the screw when screwing in with a conventional drive or impact wrench,

FIG. 5 shows a graph relating to the progression of the torque on the head of a screw over the torsion angle on the head of the screw when screwing in with a drive or impact wrench according to the invention according to a second embodiment of the invention,

FIG. 6 shows a partial illustration of a drive or impact wrench according to a third embodiment of the invention, when viewed obliquely from the front,

FIG. 7 shows a front view of the drive or impact wrench of FIG. 6 with the coupling piece removed, and

FIG. 8 shows a plurality of impact graphs as a function of different rigidities in the rotary impact system.

### DETAILED DESCRIPTION

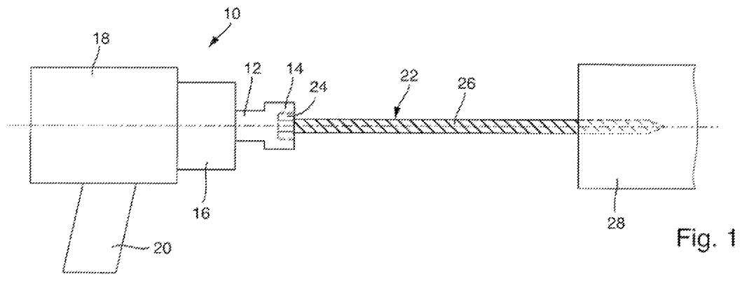

The illustration of FIG. 1 shows a drive or impact wrench 10 from the side as a schematic illustration. The drive or impact wrench 10 is illustrated schematically. An output shaft 12 has a drive formation 14 which is provided with a schematically indicated internal hexagon socket. The drive or impact wrench 10 has a drive or impact unit which is not illustrated and a drive motor which is not illustrated, which are arranged in a housing 18.

With the drive or impact wrench 10, rotary impacts are produced on the output shaft 12, in other words the output shaft is accelerated at short time intervals about the longitudinal center axis thereof. During a rotary impact, a predefined and where applicable adjustable maximum torque is not exceeded. After a predefined time, the rotary impact ends until a further rotary impact is produced a short time later.

A return stop 16 cooperates with the output shaft 12. The return stop at least partially prevents the backward rotation of the output shaft 12 after a rotary impact has been applied to the output shaft 12. The return stop 16 is in this instance constructed in such a manner that the reverse torque of the output shaft 12 which occurs on the return stop 16 can be limited to a predefined maximum value.

Conventional drive or impact wrenches have no return stop 16. An operator of a conventional drive or impact wrench does not therefore have to absorb or resist any reverse torque of the output shaft. This makes working with drive or impact wrenches very pleasant.

As a result of the return stop 16, with the drive or impact wrench according to the invention an operator must absorb the reverse torque which is limited to a maximum value by means of a handle 20 on the housing 18 or withstand it on the handle 20. The housing 18 may of course also be clamped in an apparatus or a stand so that the apparatus then applies the torque or counteracts the reverse torque.

A wood screw 22 is received with the screw head 24 thereof in the drive construction 4 of the drive or impact wrench 10. The screw head 24 is in the form of a hexagonal head. The wood screw 22 has a shaft 26 which is constructed in a cylindrical manner and which at an end opposite the screw head 24 merges into a tapering screw tip. The screw tip and screw shaft 26 are provided with a continuous thread. The wood screw 22 should be screwed into a workpiece 28. The workpiece 26 may, for example, comprise wood.

The wood screw 22 has in comparison with the diameter thereof a comparatively long cylindrical shaft 26. In the screw 22 illustrated, the length of the shaft 26 is some 20 to 25 times greater than the diameter. The invention itself is particularly advantageous with long screws which can become significantly twisted or distorted, but may of course also be used with short screws. The long cylindrical shaft 26 leads to the shaft 26, in a similar manner to a torsion bar, being able to become twisted or distorted around the longitudinal screw axis when the wood screw 22 is screwed into the workpiece 28.

With the drive or impact wrench 10, as set out, a rotary impact with a where applicable predefined maximum torque is applied to the screw head 24. At the beginning of the screwing-in operation, this leads to a complete conversion of the rotary impact into a rotational movement of the screw tip of the wood screw 22. The further the screw tip and consequently also the shaft 26 of the wood screw 22 protrude into the workpiece 28, the greater is the screwing-in torque required for continuing to screw in the wood screw 22. Ultimately, this leads to a portion of the rotary impact energy which is introduced with each rotary impact of the drive or impact wrench 10 into the screw head 24 having to be applied for the twisting or torsion of the screw shaft 26 until the torque applied to the screw 22 exceeds the required screwing-in torque.

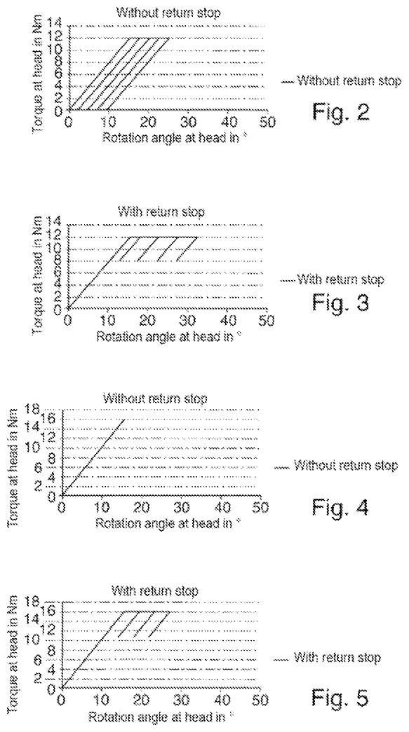

With reference to FIG. 2, it is illustrated how the torque on the screw head 24 behaves over the torsion angle on the screw head 24 with a conventional drive or impact wrench. The drive or impact wrench may apply a maximum rotary impact energy of 120 Nm°.

FIG. 2 shows that with each rotary impact the torque applied by the output shaft to the screw head increases to 12 Nm. A torsion angle of 15° is thereby achieved on the screw head. FIG. 2 shows five consecutive rotary impacts, wherein the required screwing-in torque in the workpiece 28 is 12 Nm. In order to apply this torque of 12 Nm, the screw shaft must be turned or twisted through 15°. The rotary impact energy which is required to turn or twist the shaft is calculated as the integral of the torque over the torsion angle and thus corresponds to the surface-area below the curve of FIG. 2 and is 12 Nm×15°: 2=90 Nm°. The remaining energy of the drive or impact wrench rotates the complete wood screw 22 through (120−90) Nm°/12 Nm=2.5° further into the wood. This corresponds to the short horizontal path of the curve in FIG. 2 with a constant torque. As a conventional drive or impact wrench, the drive or impact wrench used for FIG. 2 has no return stop. The user or operator consequently does not have to maintain or apply any reverse torque to the housing of the drive or impact wrench.

According to FIG. 2, after each rotary impact the screw head turns back again through 150 since the twisting of the shaft is completely cancelled and must with the next rotary impact initially be turned or twisted again through 150 by the rotary impact energy before further screwing in is possible. FIG. 2 consequently shows that, after four successive rotary impacts, the screw has been screwed through 100 into the workpiece.

FIG. 3 shows the progression of the torque on the screw head 24 over the torsion angle on the screw head 24 when the screw 22 is screwed in with the drive or impact wrench 10 according to the invention according to FIG. 1. The return stop 16 is in this instance constructed in such a manner that, after a backward rotation angle of the output shaft of 5°, it prevents further backward rotation of the output shaft 12. The drive or impact wrench 10 may apply a maximum torque of 120 Nm.

According to FIG. 3, with the first rotary impact the wood screw 22 is turned or twisted through 15°. After reaching the screwing-in torque of 12 Nm, the shaft 26 is also then screwed slightly into the workpiece, that is to say, by a further 2.5°. After the end of the rotary impact, the screw head 24 rotates back again through 5° until the return stop 16 prevents further backward rotation of the screw shaft 26. An operator must now resist on the handle 20 in order to prevent the housing 18 from turning. The next rotary impact thereby strikes a wood screw 22 which has already turned or twisted about itself through 100 and starting from this already twisted state the rotary impact is applied to the wood screw 22. In this instance, only (8+12)/2 Nm×5°=50 Nm° is required for the new turning or twisting of the screw, whereby for further rotation of the screw in the wood 70 Nm° remain available. If this value is divided by the required torque to further rotate the screw, that is to say, 12 Nm, a value of 70 Nm°: 12 Nm=5.830 is obtained. With each rotary impact from the second rotary impact, the wood screw 22 is consequently screwed further into the workpiece 28 by 5.83°. This can be seen in the graph of FIG. 3. After four successive rotary impacts, the screw according to FIG. 3 has consequently been further screwed in by 20°.

With the drive or impact wrench 10 according to the invention, the screw 22 can consequently be screwed in significantly more quickly since the wood screw 22 with each rotary impact can be screwed in through a larger angle than with a conventional drive or impact wrench without any return stop.

However, the operator must resist on the housing 18 or the handle 20 the reverse torque of 8 Nm.

FIG. 4 shows the progression of the torque on a screw head of a wood screw over the torsion angle on the screw head when a conventional drive or impact wrench without a return stop is used. FIG. 4 illustrates a case in which the screw is already deeper in the workpiece 28 and consequently the torque which is required to further screw into the workpiece 28 has risen to 16 Nm.

According to FIG. 4, the energy which is required to turn or twist the shaft of the screw is now precisely as large as the rotary impact energy of the drive or impact wrench. In this instance, with the conventional drive or impact wrench without a return stop, no further screwing in of the screw is possible because the rotary impact energy is transferred with each rotary impact completely into the turning or twisting of the shaft of the screw. After the end of the rotary impact the twisting of the screw completely decreases without further screwing-in of the screw shaft into the workpiece having been carried out.

FIG. 5 shows the progression of the torque on the screw head 24 when the drive or impact wrench 10 according to the invention according to FIG. 1 is used, wherein the torque required for screwing into the workpiece 28 is also 16 Nm.

FIG. 5 shows that with the first rotary impact the screw head 24 is turned or twisted through 15°. In this regard, this is unchanged compared with the illustration of FIG. 4. However, the backward rotation of the screw shaft is stopped by the return stop 16 after 5°. The next rotary impact consequently strikes a screw which has already been twisted through 10°. A larger portion of the rotary impact energy of the second rotary impact is consequently transferred into screwing the screw into the workpiece so that further screwing in of the screw through 3.3° is possible. Also, with the further rotary impacts, a backward rotation of the screw shaft 26 is always stopped after 5°, wherein a reverse torque of 10.67 Nm which a user has to resist on the handle 20 of the housing 18 occurs. As set out, however, the screwing-in of the wood screw 22 is according to FIG. 5 possible through 3.3° per rotary impact, whereas according to FIG. 4, with a conventional drive or impact wrench without a return stop 16, a screwing-in of the screw would not be possible at all.

It may be assumed that with more rigid screws a limitation of the backward rotation angle to 5° would bring about significantly even higher reverse torques. Consequently, for example, the return stop 16 may have a slip clutch in order to limit the reverse torque to a predefined value between 5 Nm and 30 Nm, in particular of 20 Nm. A reverse torque of 30 Nm may still be maintained by a user. If, however, the user is standing, for example, on a ladder, it is advantageous to limit the reverse torque to 20 Nm in order to prevent the user from losing balance.

As an alternative to limiting the reverse torque, the size of the backward rotation angle or the catch angle in the return stop 16 can also be changed.

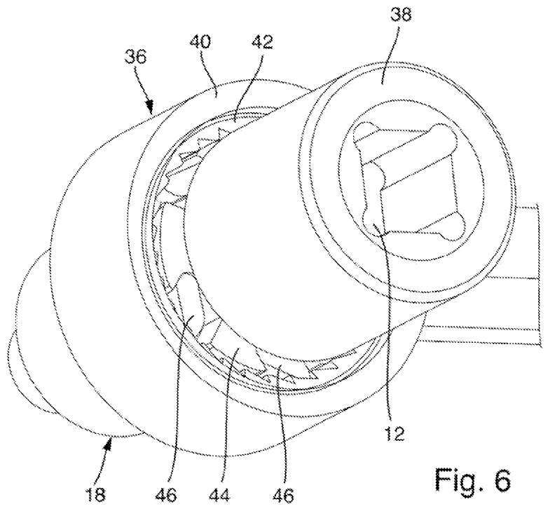

FIG. 6 shows a partial illustration of a drive or impact wrench according to the invention, wherein only one return stop 36 and a portion of the output shaft 12 and a portion of the housing 18 are illustrated. There has been placed on the output shaft 12 a clutch 38 which can then, for example, be provided with a drive socket.

FIG. 6 shows that the return stop 36 has an outer ring 40 which is provided at the inner side thereof with an internal gear ring 42. The teeth of the internal gear ring 42 are constructed in a saw-tooth-like manner. In the context of the invention, in the return stop an external gear ring and locking detents which are arranged radially outside the external gear ring may also be provided. Preferably, the locking detents are not also rotated with the output shaft. A highly dynamic construction of the return stop can thereby be achieved so that, even with very rapidly successive rotary impacts within an extremely short time, a backward rotation of the output shaft can be stopped. The locking detents may to this end be constructed to be very light but nonetheless with a high strength. A very rapid control of the locking detents in the gear ring, whether it is an internal gear ring or an external gear ring, is achieved by means of forced control of the locking detents. For the forced control of the locking detents, the backward rotation of the output shaft can be used. When the output shaft is rotated backward, stops, cams or the like then strike the locking detents and move them into the locking position in which they engage in the internal gear ring or external gear ring.

The return stop further has in the embodiment illustrated in FIG. 6 an inner ring 44 to which a plurality of locking detents 46 are pivotably articulated. The locking detents 46 are pretensioned radially outward in a manner which is not illustrated so that they assume the outwardly pivoted position illustrated in FIG. 6.

A rotation of the drive shaft 12 is possible in the illustration of FIG. 6 in a clockwise direction since in this rotation direction the locking detents 46 slide away over the teeth of the internal gear ring 42. A rotation in a counter-clockwise direction is in contrast blocked since the locking detents 46 then engage in the teeth of the internal gear ring 42. The locking detents are arranged in a state distributed over the circumference and the internal gear ring 42 is sized in such a manner that a backward rotation of the output shaft 12, that is to say, a rotation in a counter-clockwise direction, is stopped in each case after approximately 5°.

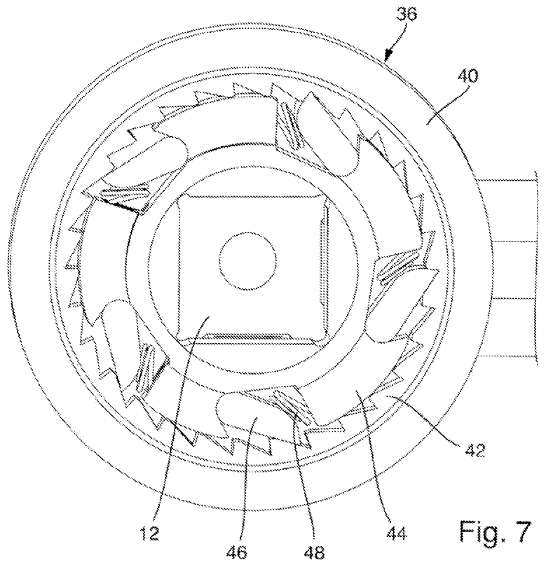

FIG. 7 shows a plan view of the return stop 36 of FIG. 6. It can be seen that a total of five locking detents 46 are pivotably arranged on the inner ring 44. Each of the locking detents 46 is pretensioned in a radially outward direction by means of a helical spring 48. In the illustration of FIG. 7, the output shaft 12 which rotates together with the inner ring 44 can consequently rotate in a clockwise direction. The screwing-in of the wood screw 22 is also carried out in a clockwise direction, see FIG. 1, by means of successive rotary impacts. A rotation of the output shaft 12 and the inner ring 44 in a counter-clockwise direction, that is to say, a backward rotation, is in contrast stopped by the engagement of the locking detents 46 in the teeth of the internal gear ring 42 on the outer ring 40.

FIG. 7 shows that only one of the locking detents 46 completely engages in each case in a tooth of the internal gear ring 42. The remaining locking detents are still in contrast on the teeth or shortly in front of the tooth base of a tooth. A very small backward rotation angle can thereby be achieved.

As set out, a connection between the output shaft 12 and the inner ring 44 can be achieved by means of a slip clutch in order to limit the reverse torque of the output shaft 12 to a predefined value.

In an embodiment (not illustrated) of a drive or impact wrench according to the invention, there is provision for the return stop to have means for changing a backward rotation angle of the output shaft. For example, the backward rotation angle can be increased when a reverse torque is too high to still be safely absorbed by a user or operator on the housing of the drive or impact wrench in a safe manner.

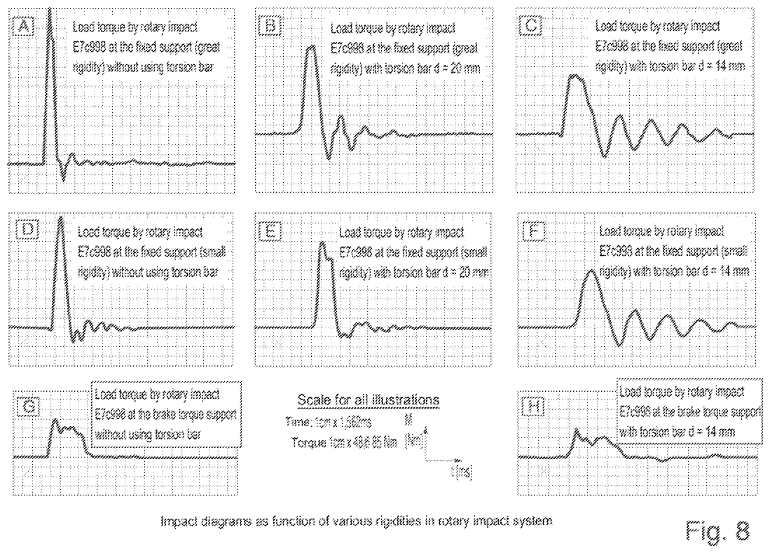

FIG. 8 shows a plurality of impact graphs as a function of different rigidities in the rotary impact system. It can be seen that with a significant rigidity in the rotary impact system, see the impact graphs A, B, C, significant vibrations which have a significant amplitude and which subside only slowly can be observed after the rotary impact. With a low rigidity in the rotary impact system, see the impact graphs D, E, however, vibrations which have a small amplitude and which subside more rapidly occur. Only in very unfavorable cases in which the rotary impact presumably excites the resonance frequency of the rotary impact system, see impact graph F, even with a low rigidity in the rotary impact system, do significant vibrations which only slowly subside occur. Significant vibrations which only slowly subside are in the long term extremely unpleasant for the operator of a rotary impact wrench.

If, in contrast, the rotary impact wrench is not rigidly supported, but instead with a brake torque support, see the impact graphs G and H, vibrations in the rotary impact system can be practically completely avoided. A brake torque support is also achieved with an in particular adjustable slip clutch with the drive or impact wrench according to the invention. With the drive or impact wrench according to the invention, screws, in particular wood screws, can therefore not only be screwed in more quickly than with conventional drive or impact wrenches, furthermore unpleasant vibrations in the rotary impact system can also be avoided or significantly reduced.

1. A drive or impact wrench, comprising:
a drive motor,
an output shaft and a drive or impact unit for accelerating the output shaft at short time intervals,
wherein a return stop which cooperates with the output shaft in order to at least partially prevent a backward rotation of the output shaft.

2. The drive or impact wrench as claimed in claim 1, wherein the return stop has means in order to limit a reverse torque, which acts on the return stop, of the output shaft to a predefined maximum value.

3. The drive or impact wrench as claimed in claim 2, wherein the means are constructed to limit the reverse torque to a value between 5 Nm and 30 Nm, in particular of 20 Nm.

4. The drive or impact wrench as claimed in claim 1, wherein the return stop is in the form of a mechanical return stop, in particular a freewheel or a ratchet having locking detents, a rolling freewheel, a freewheel having several clamping members or a spring winding freewheel.

5. The drive or impact wrench as claimed in claim 4, wherein the return stop has a ratchet having at least one locking detent and a gear ring, wherein the locking detents of the ratchet in the event of a backward rotation of the output shaft are inserted by mechanical actuation means into the gear ring of the return stop in a forcibly controlled manner.

6. The drive or impact wrench as claimed in claim 1, wherein the return stop is in the form of a brake, in particular a hydraulically actuated or mechanically actuated brake.

7. The drive or impact wrench as claimed in claim 1, wherein the return stop is constructed in a hydraulic manner, in particular in the form of a hydraulic motor.

8. The drive or impact wrench as claimed in claim 1, wherein the return stop is constructed in an electrical manner, in particular in the form of an electric motor or an electronic control unit which cooperates with the drive motor of the drive or impact wrench.

9. A return stop for use with a drive or impact wrench, wherein the return stop cooperates with an output shaft of the drive or impact wrench and wherein the return stop is constructed to at least partially prevent a backward rotation of the output shaft.

10. A method for screwing in a screw with a drive or impact wrench having a drive motor, an output shaft and a drive or impact unit for accelerating the output shaft at short time intervals, having the following steps: applying a plurality of sequential rotary impacts to the screw by means of the output shaft of the drive or impact wrench and at least partially preventing any backward rotation of the output shaft between two rotary impacts in each case.

11. The method as claimed in claim 10, further including limiting a reverse torque, which acts on a return stop of the drive or impact wrench, of the output shaft to a predefined limit value between 5 Nm and 30 Nm, in particular of 20 Nm.

12. The method as claimed in claim 10, further including adjusting a ratio between a maximum torque Mₘₐₓ which is applied by the drive or impact wrench in the event of a rotary impact and a reverse torque Mₘᵢₙ of the output shaft to a value Mₘₐₓ/Mₘᵢₙ of from 1 to 80, in particular 1 to 50, in particular 1 to 10.
